(19) United States
(12) Patent Application Publication
(10) Pub. No.: US 2008/0298740 A1
(43) Pub. Date: Dec. 4, 2008

(54) Integrated Optical Waveguide Sensors With Reduced Signal Modulation

(75) Inventors: Louis Hlousek, Fremont, CA (US); Rino E. Kunz, Kuesnacht (CH); Guy Voirin, Courgevaux (CH); Kaspar Cottier, Burgdorf (CH)

Correspondence Address: ROPES & GRAY LLP, PATENT DOCKETING 39/361, 1211 AVENUE OF THE AMERICAS, NEW YORK, NY, 10036-8704, US

(73) Assignee: Ciphergen Biosystems, Inc., Fremont, CA (US)

(21) Appl. No.: 11/596,824

(22) PCT Filed: May 18, 2005
(86) PCT No.: PCT/US05/17457

§ 371 Date: Jan. 25, 2008

Related U.S. Application Data
(60) Provisional application No. 60/572,556, filed on May 18, 2004.

(51) Int. Cl. G02B 6/00

(52) U.S. Cl. 385/12

(57) ABSTRACT

The invention provides an integrated optical waveguide sensor module (200) with reduced signal modulation and increased sensitivity. An optical waveguide sensor module (200) comprises an optically transparent substrate (210) having a first and a second interface and an optical waveguide film (220) disposed on the substrate (210) with the first interface (225) therebetween, wherein the film (220) comprises at least one grating pad (235) that is optically coupled therewith. The substrate (210) and the optical waveguide film (220) are configured to reduce parasitic interference within the substrate.

### CROSS-REFERENCE TO RELATED APPLICATION

This application claims priority to U.S. provisional patent application Ser. No. 60/572,556, filed May 18, 2004, which is incorporated by reference in its entirety.

### FIELD OF THE INVENTION

This invention is in the field of chemical and biochemical analysis, and relates particularly to integrated optical sensors for chemical and biochemical analysis.

### BACKGROUND OF THE INVENTION

The ability to detect and characterize analyte molecules with a high degree of specificity and sensitivity is of fundamental importance in chemical and biochemical analysis. Chemical and biochemical sensors have been developed that exploit a wide variety of physical phenomena in order to achieve a desirable level of sensitivity and selectivity. Such devices are particularly useful, for example, in medical diagnosis, in pharmaceutical and basic research, in food quality control, and in environmental monitoring.

A particularly important class of such sensors are those that include optical waveguides. The basic component of an optical waveguide is a multilayer structure which includes a waveguide film formed on a substrate. The optical waveguide is configured such that light of a characteristic resonance mode can be guided through the film as a result of total internal reflection.

A key parameter that determines the appropriate resonance mode of the guided light is the effective refractive index of the optical waveguide. Not only is this parameter determined by the physical characteristics and dimensions of the waveguide film, but it can be modified by the physical environment on or adjacent to the interface of the waveguide film. For example, the specific binding or adsorption of an analyte on or adjacent to the waveguide film can change its effective refractive index. Therefore, detecting and measuring this change can serve as a highly sensitive indicator of such interactions and other environmental changes.

Detecting and measuring such changes in the effective refractive index can be performed by determining the characteristic resonance mode of the light guided within the film. For example, a tunable light source, such as a laser, can be used to interrogate the optical waveguide to determine the characteristic resonance mode for a given effective refractive index. Once the incident light matches the resonance mode, its successful propagation within the waveguide film can result in a detectable signal. If the effective refractive index changes as a result of analyte sensing, the light source can be retuned until the signal is restored.

In a typical optical waveguide sensor, the waveguide film includes surface corrugations that serve as diffraction gratings. These gratings are configured to couple light into and out of the waveguide. In this manner, interrogation of the optical waveguide is performed by providing incident light to an incoupling grating, which then couples the light into the waveguide film; a separate outcoupling grating, typically disposed at a distance from the incoupling grating, can couple guided light out of the waveguide, where the excident beam can be detected as a signal.

Despite the usefulness of optical waveguide sensors, certain artifacts have been observed that have tended to diminish or limit their sensitivity, or have introduced troublesome variations in the measured signal.

One such problem is the observation of “wobble” in the measured signal. This artifact appears as an modulation in the intensity of the outcoupled light, as well as deformation of the measured peak signal, as the effective refractive index changes, such as during analyte binding. Wobble therefore diminishes both the sensitivity and accuracy of the measured signal. Previous attempts using empirical correction methods, such as by angular prescanning of the waveguide to generate a calibration curve for subtraction, provide, at best, an imperfect solution.

Accordingly, it is desirable to provide improved optical waveguide sensors and methods of use with reduced modulation and deformation of the observed signal.

It is also desirable to provide improved optical waveguide sensors and methods of use with improved sensitivity and decreased detection limits.

### SUMMARY OF THE INVENTION

The present invention solves these and other needs by providing an integrated optical waveguide sensor module with reduced signal modulation. The sensor module comprises an optically transparent substrate having a first and a second interface. An optical waveguide film is disposed on the substrate with the first interface therebetween, and the film comprises at least one grating pad that is optically coupled therewith.

In a first aspect, the present invention provides for a optical waveguide sensor module in which the substrate and the optical waveguide film are configured to reduce parasitic interference within said substrate.

In certain embodiments, the present invention provides an integrated optical sensor module with reduced signal modulation comprising an optically transparent substrate having a first and a second interface and an optical waveguide film disposed on the substrate with the first interface therebetween. The film comprises at least one grating pad that is optically coupled therewith and the substrate and the optical waveguide film are configured to reduce parasitic interference within said substrate.

In certain embodiments, the second interface of the substrate is a substrate-air interface. In certain embodiments of the present invention, an anti-reflective layer is formed on the substrate at its second interface. In certain embodiments, the anti-reflective layer may comprise MgF₂, SiO₂, TiO₂, or suitable combinations thereof. In certain embodiments, the anti-reflective layer may comprise two or more layers. In certain embodiments, the anti-reflective layer is dimensioned to reduce internal reflection at the second interface for a given angle of incidence.

In certain embodiments, the present invention provides a sensor module in which the substrate and the optical waveguide film are configured to allow coupling of incident light to at least one of the grating pads of the waveguide film. In certain embodiments, the angle of incidence of the provided incident light results in reflected light derived therefrom. The reflected light, which is internal to the substrate, is thereby incident on the second interface of the substrate at substantially the Brewster angle of the second interface.

In certain embodiments, the present invention provides a sensor module in which the period of the incident grating pad is greater than the wavelength of the incident light. In certain embodiments, the period of the incident grating pad is greater than 1.3 times the wavelength of the incident light.

In certain embodiments, the present invention provides a sensor module in which the substrate is suitably dimensioned with respect to the distance between the first and the second interfaces. In such sensor module embodiments, superposition between incident light that is transmitted through the substrate for coupling to at least one of the grating pads and internally reflected light in the substrate is substantially reduced. The internally reflected light is derived from the incident light that is reflected between the first and the second interfaces of the substrate. The reduction of superposition between the transmitted light and internally reflected light thereby reduces parasitic interference of the transmitted light within said substrate.

In certain embodiments, the present invention provides a sensor module in which the substrate is dimensioned such that the first interface of the substrate and the second interface of the substrate are substantially non-parallel. For example, the substrate may have a form with a wedge-like cross-section.

In certain embodiments, the present invention provides a sensor module in which the substrate is formed from a primary optical substrate and a secondary optical substrate that are substantially contiguous therewith. In some embodiments, the primary substrate and the secondary substrate may each have different refractive indices.

In certain embodiments, the present invention provides a sensor module comprising means for reducing the amount of incident light entering the module via the substrate, wherein said means for reduction reduces the amount of light not coupled to one of the at least one grating pads. For example, an opaque mask having at least one aperture may be disposed on the second interface of the substrate. At least one of the mask apertures may be positioned with respect to one or more grating pads on the optical waveguide on the first interface, such that at least one of the apertures allows incident light to enter the substrate through said aperture so positioned and couple with at least one of the grating pads. Similarly, at least one of the apertures may be positioned to allow excident light outcoupled from at least one of the grating pads to exit the substrate through said mask aperture so positioned.

In certain embodiments, the present invention provides a sensor module in which the first grating pad is dimensioned to reduce the amount of superimposed incident light coupled thereto. In some embodiments, the second grating pad is dimensioned to reduce the amount of superimposed excident light exiting the substrate.

In certain embodiments, the present invention provides a sensor module in which the optical waveguide film is dimensioned to act as an anti-reflective layer at the first interface of the substrate, thereby reducing internal reflection of light at the first interface for at least one wavelength and for at least one incidence angle.

In certain embodiments, the present invention provides a sensor module in which the first grating pad is configured to couple with incident light, wherein said incident light is provided to the sensor module at an incidence angle such that at least some of the reflected light derived therefrom is incident on the second interface at substantially the Brewster angle of the second interface of the substrate. In some embodiments, configuring the first grating pad in the foregoing manner includes setting or adjusting the period of the first grating pad.

In certain embodiments, the present invention provides a dual-period sensor module in which the period of first grating pad is different from the period of the second grating pad. In certain embodiments, the sensor module is a depth-modulated sensor module, whereby the thickness of the optical waveguide film at the first grating pad is different from the thickness of the optical waveguide film at the second grating pad.

In certain embodiments, the present invention provides a sensor module comprising an adlayer disposed on the optical waveguide film. In some embodiments, the adlayer comprises a surface suitable for surface-enhanced laser desorption/ionization of analytes disposed thereon or therein. In preferred embodiments, binding of analytes to this adlayer may effect the properties of the optical waveguide film.

In another aspect, the present invention provides an integrated optical sensor module with improved detection limit, the sensor module comprising an optically transparent substrate and an optical waveguide film disposed on the substrate. The film comprises a first grating pad configured to couple incident light from the substrate into the optical waveguide film, wherein the incident light is provided at an angle substantially equal to the Brewster angle of the substrate, and a second grating pad configured to couple guided light from within the optical waveguide film to the substrate. In some embodiments, the first grating has a period of at least the wavelength of the incident light.

### BRIEF DESCRIPTION OF THE DRAWINGS

The above and other objects and advantages of the present invention will be apparent upon consideration of the following detailed description taken in conjunction with the accompanying drawings, in which like characters refer to like parts throughout, and in which:

FIG. 1 is a schematic cross-sectional view of an optical waveguide sensor module to illustrate parasitic interference phenomena present in certain prior art devices;

FIG. 2 is a schematic cross-sectional view of an optical waveguide sensor module embodiment of the present invention;

FIG. 3 is a schematic cross-sectional view of an optical waveguide sensor module embodiment of the present invention having an anti-reflective layer;

FIG. 4 is a schematic cross-sectional view of an optical waveguide sensor module embodiment of the present invention illustrating the use of Brewster angles;

FIGS. 5A and 5B are schematic cross-sectional views of optical waveguide sensor module embodiments of the present invention having different substrate heights;

FIG. 6 is a schematic cross-sectional view of an optical waveguide sensor module embodiment having a wedge-shaped substrate layer;

FIG. 7 is a schematic cross-sectional view of an optical waveguide sensor module embodiment illustrating selected geometric parameters;

FIG. 8 is a schematic cross-sectional view of an optical waveguide sensor module embodiment illustration selected geometric parameters; and

FIG. 9 is a schematic top view of an embodiment of the present invention having an plurality of optical waveguide sensor modules.

### DETAILED DESCRIPTION OF THE PREFERRED EMBODIMENTS

The apparatus and methods of the present invention provide improved integrated optical waveguide sensor modules that are configured to reduce the undesired phenomenon of internal parasitic interference. Such improved apparatus and methods therefore result in optical waveguide modules and associated apparatus with improved sensitivity and accuracy. In another aspect of the present invention, apparatus and methods are provided that decrease the detection limits of an integrated optical waveguide sensor module, thereby also increasing its sensitivity. Moreover, embodiments of the present invention may be used individually as well as in suitable combinations, thereby providing even greater improvements.

Parasitic interference results from the superposition of separated light beams that originate from a common source beam. Separated light beams may arise during the transmission of the original source beam through a refractive medium having internally reflective interfaces. Although a component of the beam will follow the refracted path through the medium without internal reflection, another component of the beam may undergo multiple internal reflections at the interfaces of the substrate. If this multiply-reflected beam is superimposed on the unreflected component, any difference in their respective phases may result in interference between the beams, with consequent attenuation or modulation of the eventual signal. This parasitic interference may therefore decrease the sensitivity and accuracy of the optical sensor.

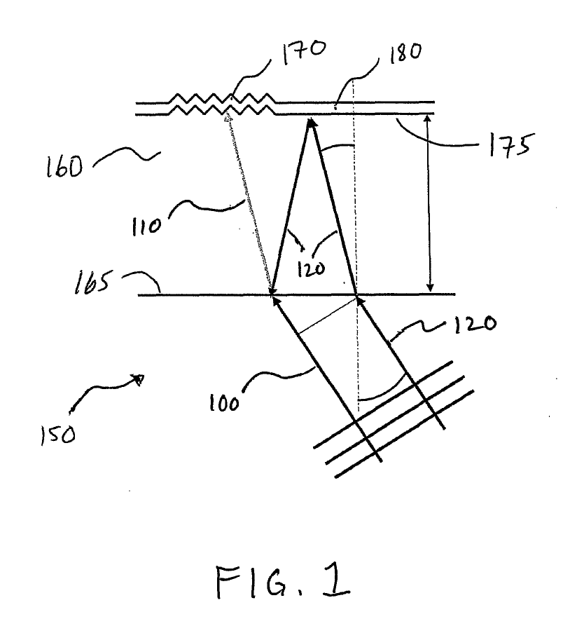

Referring to FIG. 1, a hypothetical depiction of parasitic interference, as it may occur in a prior art device, is depicted. In FIG. 1, original incident light beam 100 is refracted at substrate-air interface 165 of optical waveguide sensor 150 and, as depicted by path 110 through substrate 160, may then be coupled into waveguide 180 via grating pad 170. However, another component of the original incident beam may instead undergo internal reflection at both substrate-film interface 175 and substrate-air interface 165, thereby following path 120. Upon superposition of this doubly-reflected beam on the unreflected beam 110, interference may result between the two beams if there is a relative phase shift. This interference may then result in modulation of the eventual sensor signal. Moreover, in applications in which wavelength scanning of the incident light is performed, such as in wavelength interrogated optical scanning (WIOS), the extent of the interference may vary with the wavelength. As a result, sinusoidal modulation of the signal may also be observed as a result of this wavelength-dependent interference.

In an analogous manner, parasitic interference may occur with an excident light beam. Moreover, because the interrogating light beam in many optical waveguide sensors have both an incident and excident component, interference may occur at both locations and therefore further modulate the eventual signal.

Previous apparatus and methods to correct parasitic interference resulting from internal reflection, such as angle scanning of the optical waveguide (see Cottier et al., Sensors and Actuators B 91, 241-251 (2003), attempted to correct the resulting attenuated signal without addressing the underlying problem of parasitic interference in optical waveguide sensors. Such error correction methods may even have been counterproductive, as the attenuation and modulation that results from angle-scanning arises from a process fundamentally different the attenuation and modulation that results from changes to the effective refractive index of the waveguide. Hence use of such calibration methods may further confound accurate and sensitive analysis.

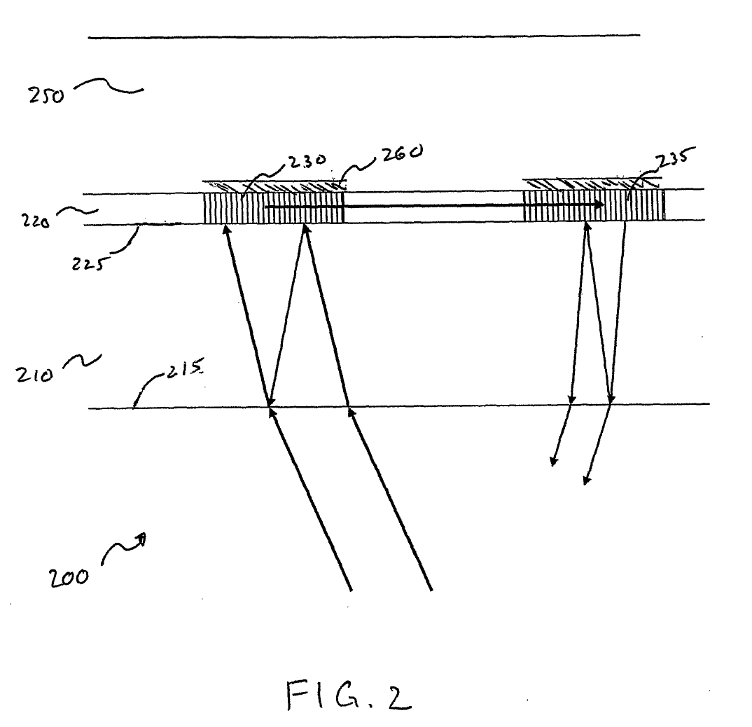

Referring to FIG. 2, an embodiment of an integrated optical waveguide module of the present invention is depicted. Features in this embodiment that are common to other embodiments of the present invention are presumed to be substantially the same, unless otherwise described.

Integrated optical waveguide module 200 comprises waveguide film 220 formed on substrate layer 210. Substrate 210 further defines two interfaces, a first interface between substrate 210 and film 220 (substrate-film interface 225) and a second interface between substrate 210 and air (substrate-air interface 215).

Substrate 210 may be composed of materials such as glass (e.g., borosilicate glass), plastic, or other materials having suitable optical properties that are known in the art. In preferred embodiments, such substrates exhibit minimal scattering and absorptive properties with respect to light.

Waveguide film 220 includes input grating pad 230 and output grating pad 235. These grating pads are diffraction gratings that serve to couple light respectively into and out of waveguide film 220. In preferred embodiments of the present invention, each is formed from surface corrugation with a given periodicity on waveguide film 220. Waveguide film 220 may comprise a suitable dielectric material, such as tantalum pentoxide (Ta₂O₅).

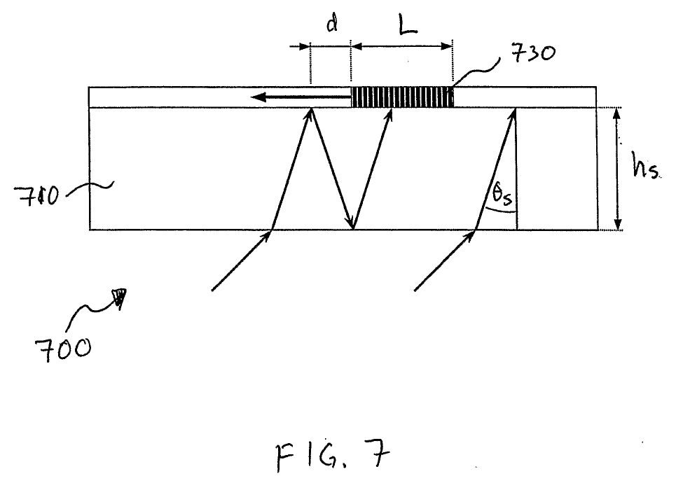

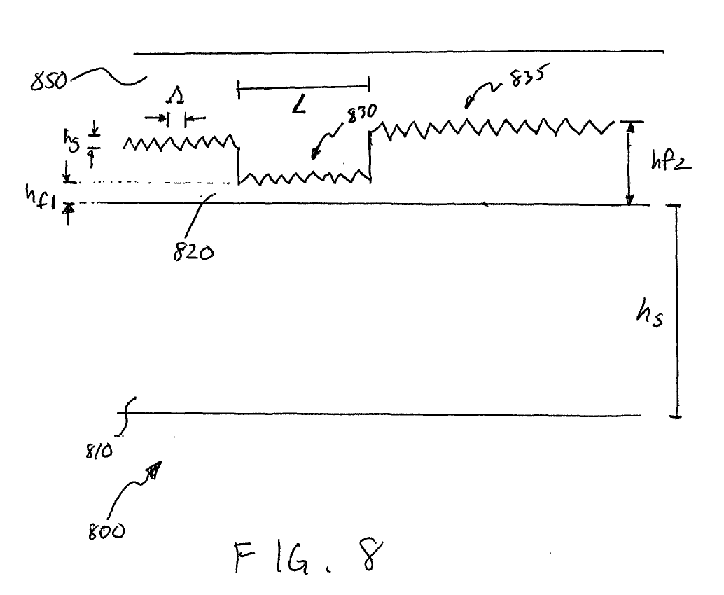

In some embodiments of the present invention, characteristics of the grating pad may be suitably configured, as is known in the art, in order to modify its light coupling properties. For example, the periodicity of a grating pad may be suitably configured, thereby determining the angles of the incident or excident light suitable for coupling with the grating pad. In some embodiments, chirped grating pads may be used, in which the grating pad has a gradient of periodicity along an axis. In some embodiments of the present invention, other characteristics of the grating pads that may also be suitably configured include the thickness of waveguide film 220 (see, e.g., the dimension labeled h_{f1} and h_{f2} in FIG. 8), the depth of the lines of diffraction (see, e.g., the dimension labeled h_{g} in FIG. 8), and the length of the grating pad with respect to the axis of the waveguide (see, e.g., the dimension labeled L in FIGS. 7 and 8). Other characteristics of the grating pad and its diffraction grating may be configured, as are known in the art. Moreover, the characteristics of each incoupled and outcoupled grating pad may be separately configured when constructed. For example, the incoupling grating pad may have a period, thickness, length, grating depth, or other parameter that is different from the outcoupling grating pad. For example, in some embodiments a sensor module may be a dual-period sensor module, in which the incoupling and outcoupling grating pads have different grating periods. In some embodiments a sensor module may be a depth-modulated sensor module, in which the thickness of the waveguide film is different between the incoupling and outcoupling grating pads.

In still other embodiments, the optical sensor may comprise only an outcoupling grating pad, as light is introduced into the waveguide by other means and components known in the art. In some other embodiments, the present invention includes optical waveguide sensors in which a single grating pad may serve as both the incoupling and outcoupling pad.

When sensor module 200 is used as an optical sensor, a target sample is provided in cover layer 250. The cover layer contacts waveguide film 210 on the side opposite to that of substrate-film interface 225 and substrate 210. In some embodiments of the present invention, an analyte sample may be provided in bulk volume that occupies cover layer 250. In other embodiments of the present invention, an optional adlayer may be first provided on the film, such as adlayer 260. The sample is then provided in cover layer 250 and allowed to contact adlayer 260. Adlayer 260 may include species that are capable of interacting with desired analytes in the sample, such as by chemical, physical, enzymatic, or other suitable interactions as are known in the art, examples of which are described in U.S. Pat. Nos. 4,815,843 and 6,346,376, the disclosures of which are incorporated herein by reference in their entireties. Such interactions between the desired analyte and adlayer 260 may result in detectable changes to the effective refractive index of the waveguide.

Adlayer 260 may include one or more adsorptive surfaces or species, such as those found on affinity capture probes. For example, adlayer 260 may include chromatographic adsorption surfaces and biomolecule affinity surfaces. Typically, such chromatographic adsorption surface is selected from the group consisting of reverse phase, anion exchange, cation exchange, immobilized metal affinity capture and mixed-mode surfaces and the biomolecule of the biomolecule affinity surfaces is selected from the group consisting of antibodies, receptors, nucleic acids, lectins, enzymes, biotin, avidin, streptavidin, Staph protein A and Staph protein G.

In a first aspect of the present invention, apparatus and methods are provided for reducing the parasitic interference in integrated optical waveguide sensor modules.

In some embodiments, parasitic interference in the optical waveguide sensor is reduced by reducing internal reflection of incident or excident light at the substrate interfaces. By reducing the amount of internally reflected light in the substrate, the amount of superposition between interfering waves that may cause parasitic interference is correspondingly reduced.

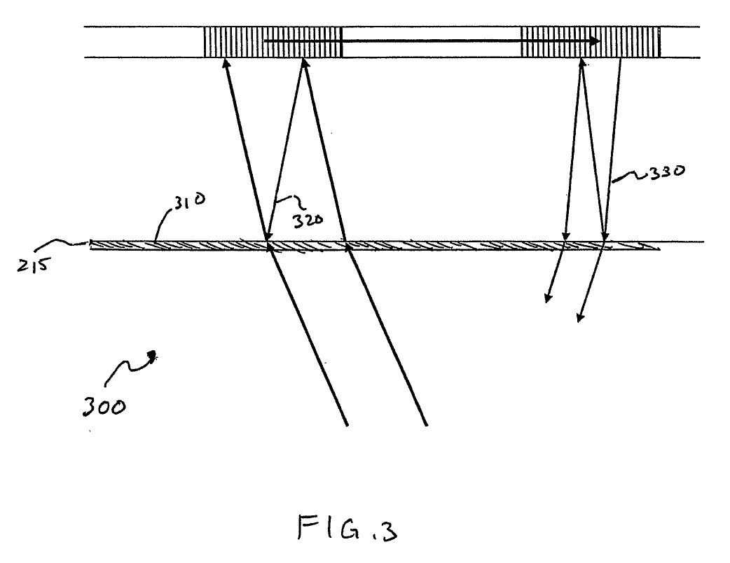

For example, in some embodiments of the present invention, a substrate layer may further comprise an anti-reflective layer at its substrate-air interface. Referring to FIG. 3, anti-reflective layer 310 of optical sensor 300 is configured to reduce internal reflection at substrate-air interface 215. When reflected incident light 320 or excident light 330 arrives at interface 215, further reflection of either light beam may be reduced. As a result of decreasing the reflectivity of the interface, the amount of parasitic interference is likewise reduced.

Suitable materials and dimensions for optical anti-reflective layers are known in the art. For example, anti-reflective layers may comprise magnesium fluoride (MgF₂), silicon dioxide (SiO₂), titanium dioxide (TiO₂), and other suitable materials. Moreover, in some embodiments anti-reflective layers may comprise two or more layers (e.g., SiO₂/TiO₂ layers) that form a combined anti-reflective layer. In some embodiments, certain properties of the anti-reflective layer, such as its refractive index or its thickness, may be suitably configured in order to reduce reflection of light having a particular angle of incidence and/or wavelength. In such embodiments, the optical waveguide sensor may be configured in coordination with such an anti-reflective layer. For example, the outcoupling grating pad may be configured such that the angle of the excident beam from the outcoupling grating pad matches the optimal anti-reflective angle of the substrate interface, thereby reducing the internal reflection at this interface. Similarly, incident light may be provided at an angle such that it is incident on the interface at the optimal angle for anti-reflectivity. Anti-reflective layers are particularly suitable in embodiments in which TE (transverse electric) polarization of the incident or excident light is desired.

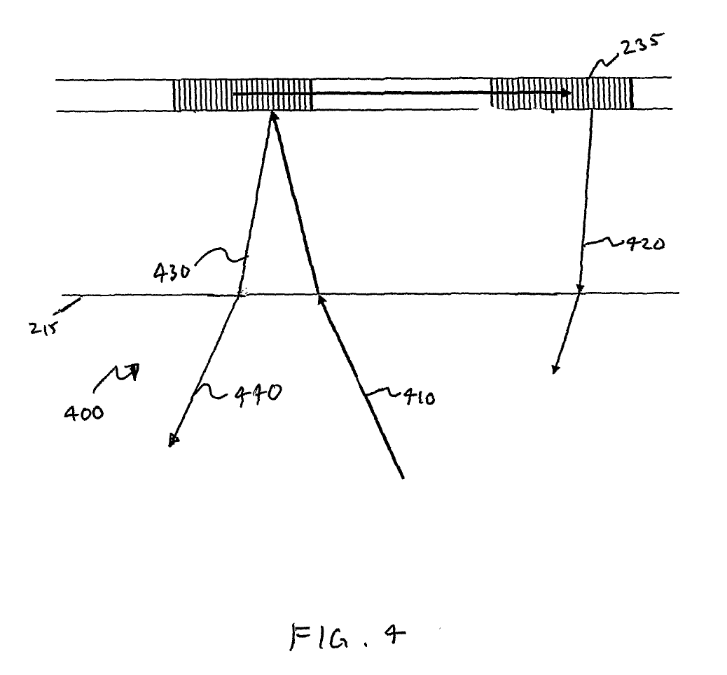

In some embodiments of the present invention, the optical waveguide may be configured such that the incident or excident light operates at the appropriate Brewster angle for a given substrate interface. For example, as depicted in FIG. 4, incident light 410 may be provided to optical waveguide sensor 400 such that its angle of incidence at interface 215 following a first internal reflection is substantially at the appropriate Brewster angle. At this Brewster angle, the light incident on the substrate interface (430) is nearly fully transmitted (440) rather than reflected. Similarly, outcoupling grating pad 235 may be configured such that the outcoupled excident light 420 impinges on interface 215 at substantially the appropriate Brewster angle, thereby also inhibiting reflection. Operating at the Brewster angle is particularly suitable in embodiments in which TM(transverse magnetic) polarization of the incident or excident light is desired.

In some embodiments of the present invention, both anti-reflective layers and the use of Brewster angles, as described above, may be used in suitable and effective combinations. Furthermore, the use of Brewster angles may necessitate light beams having relatively large angles of incidence or excidence. Therefore, in some embodiments of the present invention in which Brewster angles are used to reduce interfacial reflection, the grating pads are configured accordingly to appropriately couple light at such angles. For example, in order to effect coupling of light with large angles of incidence or excidence, the respective grating pad may require significantly larger periods. As described below, increasing the periodicity of a grating pad to values such as 900 nm or 1000 nm has the unexpected effect of increasing the sensitivity of the waveguide.

In another aspect of the present invention, parasitic interference within the substrate that results from superposition of reflected light may be reduced by geometrical optimization of the optical waveguide sensor. Such geometrical optimization may involve, for example, fabricating a substrate layer of an optical waveguide sensor module with suitable dimensions and/or geometry such that superposition, and hence parasitic interference, may be reduced.

Referring to FIG. 7, optical waveguide sensor 700 is depicted showing the superposition of reflected light when incoupling to grating pad 730. As labeled in FIG. 7, the overlap ratio between the reflected light beam when incoupling may be expressed as follows:

OR=Max{0,(L+d−2hₛ sin |θₛ|)/L} (1)

where OR is the overlap ratio between both beams, L is the length of grating pad 730, d is the unused portion of the incidence beam (i.e., the portion of the beam that is not incident on and hence will not couple with grating pad 730), hₛ is the height of substrate layer 710, and θₛ is the angle of incidence of the beam on the waveguide. Superposition of excident light outcoupled from the outcoupled grating pad can also be defined by an analogous relationship.

Therefore, superposition and hence parasitic interference can be reduced by minimizing the value of OR. Accordingly, in certain embodiments of the present invention, the length of grating pad (L) is reduced, thereby reducing superposition. In such embodiments, decreasing the size of the grating pad may result in less incoupling of light that is subject to superposition interference. Similarly, increasing the incidence angle (θₛ) may also decrease superposition in a similar manner.

In some embodiments of the present invention, superposition may be decreased by decreasing the size of the incident or excident beam. Decreasing the beam size may therefore result in less internally reflected light made available for parasitic interference. The beam size may be decreased by focusing of the incident light source, or masking the incident light source with, for example, an opaque mask with an appropriately configured aperture. The opaque mask may disposed on the substrate second interface to block incident from entering the substrate, except for the light that enters via the aperture. The aperture is suitably positioned and sized so that light passing through is directed to the incoupled grating pad.

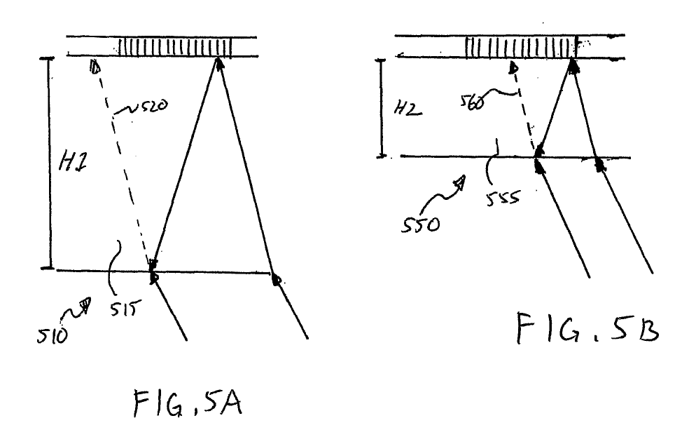

In some embodiments of the present invention, the optical waveguide sensor includes a substrate layer which may be suitably dimensioned to reduce the overlap between reflected and non-reflected light beams, thereby reducing parasitic interference. For example, referring to FIGS. 5A and 5B, optical sensor 510 in FIG. 5A comprises substrate layer 515 having a height H1, wherein this height is relatively larger than the corresponding height H2 of substrate layer 555 of optical sensor 550 shown in FIG. 5B. As depicted in FIG. 5A, internally reflected light 520 in substrate 515 will have a greater lateral displacement than internally reflected light 560 in substrate 555 in FIG. 5B. As a result of this increased displacement, superposition and the resulting parasitic interference may be reduced. Accordingly, a substrate layer of an optical waveguide sensor may be dimensioned to achieve a similar result.

In some embodiments of the present invention, the same effect may be achieved by augmenting the primary substrate layer of an existing optical waveguide sensor by the addition of an additional secondary substrate layer. In some embodiments of the present invention, the refractive indices of the primary and second layers are matched. Reflection at their mutual interface may be reduced by application of an index matching fluid, as is known in the art.

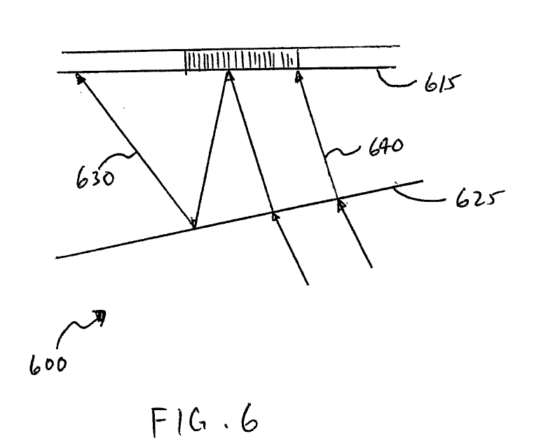

In some embodiments of the present invention, a substrate layer of an optical waveguide sensor may be formed or augmented to have a “wedge”-like cross-section. Referring to FIG. 6, optical sensor 600 comprises substrate layer 610 dimensioned with a wedge-like cross-section. The configuration depicted in FIG. 6, like those in the other figures, is depicted in a schematic manner and is not necessarily to scale. In such embodiments, first interface 615 and second interface 625 are substantially non-parallel, such that one interface is tilted with respect to the other. As a result, the respective vectors of internally reflected light 630 and original incident light 640 may be less suitable for superposition, reducing parasitic interference.

In certain embodiments of the present invention, superposition may be decreased by reducing the reflectivity at the substrate-film interface. Unlike the substrate-air interface, the presence of the waveguiding film prevents application of an additional anti-reflective layer. However, the waveguiding film itself, when properly configured with respect to its thickness and refractive index, may act as anti-reflective layer, as is known in the art. Moreover, a suitable configuration of the incoupling and outcoupling grating pads may also reduce the overall reflectivity of the substrate.

Referring to FIG. 8 and Table 1 below, selected properties and parameters of three exemplary optical waveguide sensors (A, B, and C) are shown, focusing particularly on the properties of the incoupling grating (“Inpad”) and the outcoupling (“Outpad”) grating of each sensor. In optical sensor 800, which is representative of these three sensors, the index of refraction of substrate 810 (nₛ) is 1.52 (corresponding to borosilicate glass), the substrate thickness (hₛ) is 0.7 mm, the index of refraction of waveguiding film 820 (n_{f}) is 2.10, the index of refraction of cover layer 850 (n_{c}) is 1.328 (corresponding to water), and the center wavelength is 763 nm with a TM polarization.

TABLE 1

| | | | | | | | OR | Mₚₚ | Detection limit |
|---|---|---|---|---|---|---|---|---|---|
| Pad | hf (nm) | Λ(nm) | L (mm) | hg (nm) | θ(°) | rs (%) | (d = 0 mm) | (%) | δΓ (fg/mm²) |
| Inpad A | 150 | 360 | 1 | 12 | −30.8 | 3.4 | 0.53 | | 132 |
| Outpad A | 300 | 360 | 1 | 12 | −15.0 | 6.6 | 0.76 | 33.7 | |
| Inpad B | 185 | 900 | 0.8 | 12 | 56.9 | 0.03 | 0.04 | | 65 |
| Outpad B | 185 | 360 | 0.4 | >12 | −26.3 | 1.1 | 0 | 0.12 | |
| Inpad C | 140 | 1000 | 0.8 | 12 | 55.8 | 0.12 | 0.05 | | 54 |
| Outpad C | 140 | 360 | 0.4 | >12 | −32.0 | 3.9 | 0 | 0.48 | |

In Table 1, h_{f} if is the thickness of waveguide film 820 at grating pads 830 and 835, Λ is the period of the grating pad, L is the length of the grating pad, h_{g} is the depth of the grating diffraction lines, θ is the coupling (incidence or excidence) angle on the grating pad, rₛ is the combined reflection coefficients, OR is the overlap ratio, Mₚₚ is the peak-to-peak modulation, and δΓ is the detection limit.

As shown in Table 1, a current optical sensor A is compared to improved sensors B and C of the present invention. Minimizing reflection in B and C, and hence reducing superposition and parasitic interference, can be achieved by the combination of choosing an optimized film thickness (hf) to minimize reflectivity, choosing a reduced grating pad length (L) to reduce superposition of reflected light, providing incident light to the incoupling grating pad at the appropriate Brewster angle (θ, and increasing the period (Λ) of the incoupling grating pad to accommodate incident light at this relatively large angle.

As evident from Table 1, both B and C show significantly reduced reflection coefficients compared to the current sensor A. Surprisingly, increasing the period of the incoupling grating pad significantly also acts to increase the sensitivity of the optical sensor with provision of a lower detection limit.

In another aspect, the present invention describes an integrated optical waveguide module that can be used in a variety of apparatuses and analytical methods, as is known in the art. For example, the optical waveguide of the present invention may be used in any suitable optical detection scheme such as, but not limited to, grating coupled ellipsometry, chirped grating coupling spectroscopy, wavelength interrogated optical scanning (WIOS), optical waveguide lightmode spectroscopy (OWLS), calorimetric resonant reflection detection, Mach-Zehnder and Young inferometers, and grating coupled fluorescence detection.

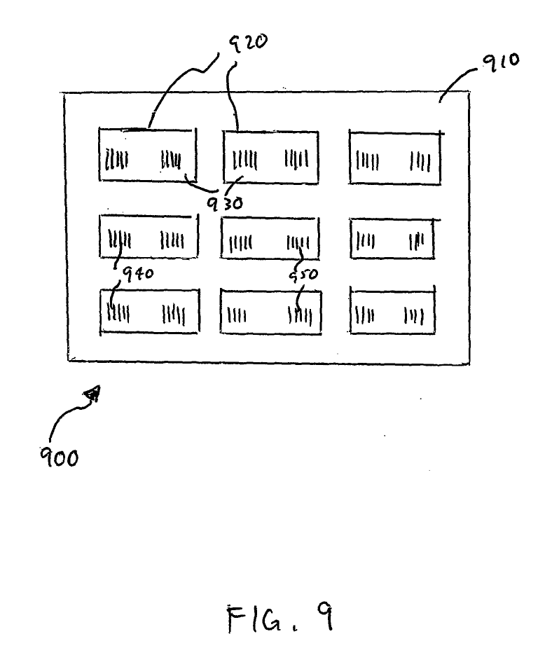

In another aspect of the present invention, a substrate may comprise two or more optical modules. Referring to FIG. 9, multi-sensor chip 900 comprises a substrate 910 and a plurality of individual sensor modules 920. Each module comprises waveguiding film 930, incoupling grating pad 940, and outcoupling grating pad 950. Chip 900 is depicted as one example, and other suitable arrangements and configurations of multi-sensor chips are within the present invention.

In another aspect, optical waveguide sensor modules of the present invention may be incorporated into cuvettes, ganged cuvettes, microtiter plates, and other suitable laboratory and diagnostic container ware. Such embodiments may allow for easier handling of the sample and the sensor. Furthermore, such embodiments may facilitate interrogation of the sample, as equipment designed to handle such form factors, such as cuvettes and microtiter plates of various sizes, are well-known and understood in the art, and may be commercially available.

In another aspect, the present invention provides an optical waveguide sensor which may also serve as a mass spectrometry substrate. For example in reference to FIG. 2, adlayer 260 disposed on waveguiding film 220 may comprise a surface suitable for SELDI (surface enhance laser desorption ionization) mass spectrometry analysis. In some embodiments of the present invention, the adlayer may comprise, for example, means for analyte binding such as antibody, affinity matrices, receptors, or other suitable specifies. Therefore, interaction between analytes and such binding means in the adlayer can be detected and measured by the optical waveguide sensor. Moreover, if the analyte is sufficiently immobilized, the same substrate may directly serve in SELDI-MS analysis. In some embodiments, the adlayer may comprise, for example, monomers and/or polymers that have energy absorbing moieties suitable for surface-enhanced neat desorption (SEND) of analytes disposed therein, such as the monomers and polymers described in U.S. patent application publications 2003/0207462 and 2003/0207460, the disclosures of which are incorporated herein by reference in their entireties. Other suitable combined applications using laser desorption/ionization analysis are within the scope of the present invention.

It is understood that all of the embodiments of the present invention, as described above, may be used individually in optical sensors or may be combined in suitable manners within a single optical sensor or apparatus.

All patents, patent publications, and other published references mentioned herein are hereby incorporated by reference in their entireties as if each had been individually and specifically incorporated by reference herein. By their citation of various references in this document, applicants do not admit that any particular reference is “prior art” to their invention.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined not with reference to the above description, but instead should be determined with reference to the appended claims along with their full scope of equivalents.

1. An integrated optical sensor module comprising:
an optically transparent substrate having a first and a second interface; and
an optical waveguide film disposed on the substrate with the first interface therebetween, wherein:
the film comprises at least one grating pad that is optically coupled therewith, and
the substrate and the optical waveguide film are configured to reduce parasitic interference within said substrate, thereby reducing signal modulation in the sensor module.

2. The sensor module of claim 1, wherein the at least one grating pad comprises:
a first incoupled grating pad configured to couple incident light from the substrate into the optical waveguide film; and
a second outcoupled grating pad configured to couple guided light from within the optical waveguide film to the substrate.

3. The sensor module of claim 1, wherein the at least one grating pad comprises:
a grating pad configured to couple incident light from the substrate into the optical waveguide film and to couple guided light from within the optical waveguide film to the substrate.

4. The sensor module of claim 1 further comprising:
an anti-reflective layer disposed on the second interface of the substrate, whereby:
the anti-reflective layer reduces parasitic interference within said substrate.

5. The sensor module of claim 4, wherein the anti-reflective layer is configured to reduce internal reflection at the second interface of the substrate.

6. The sensor module of claim 4, wherein
the anti-reflective layer comprises a MgF₂ layer.

7. The sensor module of claim 4, wherein
the anti-reflective layer comprises a SiO₂ layer and a TiO₂ layer.

8. The sensor module of claim 4, wherein the anti-reflective layer is dimensioned to reduce internal reflection at the second interface for a given angle of incidence.

9. The sensor module claim 1:
wherein the substrate and the optical waveguide film are operationally configured to allow coupling of incident light to one of the at least one grating pads, and
wherein the angle of incidence of said incident light results in reflected light derived therefrom that is incident on the second interface at substantially the Brewster angle of the second interface,
thereby reducing parasitic interference within said substrate.

10. The sensor module of claim 9, wherein the period of the incident grating pad is greater than the wavelength of the incident light.

11. The sensor module of claim 9, wherein the period of the incident grating pad is greater than 1.3 times the wavelength of the incident light.

12. The sensor module of claim 1, wherein the substrate is dimensioned such that the distance between the first and the second interfaces is sufficient to reduce superposition between:
light directly transmitted through the substrate for coupling to one of the at least one grating pads, and
said same light following multiple reflections between the first and the second interfaces of the substrate,
whereby said reduction of superposition reduces parasitic interference within said substrate.

13. The sensor module of claim 1, wherein:
the substrate is dimensioned such that the first interface and the second interface are substantially non-parallel.

14. The sensor module of claim 1, wherein:
the substrate comprises a primary and a secondary optical substrate that are substantially contiguous therewith,
wherein the combined refractive index of said contiguous substrates reduces parasitic interference within said substrate.

15. The sensor module of claim 14, wherein the primary and the second substrate have different refractive indices.

16. The sensor module of claim 1 further comprising:
means for reducing the amount of incident light entering the module via the substrate, wherein said means for reduction reduces the amount of light not coupled to one of the at least one grating pads.

17. The sensor module of claim 16, wherein the means for reducing comprises an opaque mask having an aperture.

18. The sensor module of claim 2, wherein the first grating pad is dimensioned to reduce the amount of superimposed incident light coupled thereto.

19. The sensor module of claim 2, wherein the second grating pad is dimensioned to reduce the amount of superimposed excident light exiting the substrate.

20. The sensor module of claim 1, wherein:
the optical waveguide film is dimensioned to act as an anti-reflective layer at the first interface of the substrate,
whereby the optical waveguide film reduces parasitic interference within said substrate.

21. The sensor module of claim 2, wherein the first grating pad is configured to couple with incident light, wherein said incident light is provided to the sensor module at an incidence angle such that reflected light derived therefrom is incident on the second interface at substantially the Brewster angle at the second interface of the substrate.

22. The sensor module of claim 21, wherein said configuration of the first grating pad comprises configuration of the period of the first grating pad.

23. The sensor module of claim 2, wherein the sensor module is a dual-period sensor module, whereby the period of first grating pad is different from the period of the second grating pad.

24. The sensor module of claim 23, wherein the sensor module is a depth-modulated sensor module, whereby the thickness of the optical waveguide film at the first grating pad is different from the thickness of the optical waveguide film at the second grating pad.

25. The sensor module of claim 1 further comprising an adlayer disposed on the optical waveguide film.

26. The sensor module of claim 25, wherein the adlayer comprises a surface suitable for surface-enhanced laser desorption/ionization of analytes disposed thereon or therein.

27. An integrated optical sensor module with improved detection limit, the sensor module comprising:
an optically transparent substrate; and
an optical waveguide film disposed on the substrate,
wherein the film comprises:
a first grating pad configured to couple incident light from the substrate into the optical waveguide film, wherein the incident light is provided at an angle substantially equal to the Brewster angle of the substrate, and
a second grating pad configured to couple guided light from within the optical waveguide film to the substrate.

28. The sensor module of claim 27, wherein the first grating has a period of at least the wavelength of the incident light.
